(19) United States
(12) Patent Application Publication
(10) Pub. No.: US 2025/0293755 A1
(43) Pub. Date: Sep. 18, 2025

(54) MULTI-ANTENNA PANEL TRANSMISSION AND RECEPTION

(71) Applicant: Lenovo (Singapore) Pte. Limited, Singapore (SG)

(72) Inventor: Colin Frank, Park Ridge, IL (US)

(73) Assignee: Lenovo (Singapore) Pte. Limited, Singapore (SG)

(21) Appl. No.: 18/859,723

(22) PCT Filed: Apr. 25, 2023
(86) PCT No.: PCT/IB2023/054236

§ 371 Date: Oct. 24, 2024

Related U.S. Application Data
(60) Provisional application No. 63/334,611, filed on Apr. 25, 2022.

(51) Int. Cl. H04B 7/06; H04B 17/20; H04B 17/309; H04W 52/36

(52) U.S. Cl. CPC H04B 7/06956; H04B 17/203; H04B 17/346; H04W 52/367

(57) ABSTRACT

Various aspects of the present disclosure relate to a communication device (e.g., a user equipment (UE)) that transmits a first signal via a first antenna panel of a set of antenna panels to a first transmission-reception point (TRP) in a first transmission direction, and transmits a second signal via a second antenna panel to a second TRP in a second transmission direction. The communication device limits interference between the first antenna panel and the second antenna panel, where the interference by the first antenna panel is limited based on effective isotropic radiated power (EIRP) from the first antenna panel in the second transmission direction toward the second TRP, and the interference by the second antenna panel is limited based on the EIRP from the second antenna panel in the first transmission direction toward the first TRP.

### RELATED APPLICATION

This application claims priority to U.S. Provisional Application Ser. No. 63/334,611 filed Apr. 25, 2022 entitled “Multi-Antenna Panel Transmission and Reception,” the disclosure of which is incorporated by reference herein in its entirety.

### TECHNICAL FIELD

The present disclosure relates to wireless communications, and more specifically to multi-antenna panel testing for transmission and reception.

### BACKGROUND

A wireless communications system may include one or multiple network communication devices, such as base stations, which may be otherwise known as an eNodeB (eNB), a next-generation NodeB (gNB), core network functions (CNFs), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system, such as time resources (e.g., symbols, slots, subslots, mini-slots, aggregated slots, subframes, frames, or the like) or frequency resources (e.g., subcarriers, carriers). Additionally, the wireless communications system may support wireless communications across various radio access technologies (RATs) including third generation (3G) RAT, fourth generation (4G) RAT, fifth generation (5G) RAT, and other suitable RATs beyond 5G. In some cases, a wireless communications system may be a non-terrestrial network (NTN), which may support various communication devices for wireless communications in the NTN. For example, an NTN may include network entities onboard non-terrestrial vehicles such as satellites, unmanned aerial vehicles (UAV), and high-altitude platforms systems (HAPS), as well as network entities on the ground, such as gateway entities capable of transmitting and receiving over long distances.

In 3GPP, there are two frequency ranges designated FR1 and FR2, where FR1 corresponds to the frequency range of 410 MHz-7125 MHZ, and FR2 corresponds to the frequency range 24250 MHz-52600 MHz. A communication device, such as a UE, operating in FR2 (also referred to as a FR2 device) has requirements on the minimum peak effective isotropic radiated power (EIRP) that the device must achieve in at least one direction. This minimum requirement is a function of the power class and the frequency band. The other requirement that the device must achieve is a coverage requirement, which is a lower bound on the cumulative distribution function of the EIRP measured over a sphere. Specifically, the requirement is a lower bound on the EIRP that must be achieved at a specified percentile of the cumulative distribution function. The percentile that is specified depends on the power class and the corresponding device type, where the device type reflects both the form factor and the intended use of the device. Similar peak and spherical coverage requirements are defined for the effective isotropic sensitivity (EIS). However, the peak EIS is defined as an upper bound on the minimum value of the EIS in the receive beam peak direction and the coverage requirement is defined in terms of the complementary cumulative distribution function. Similar to the EIRP, the EIS requirements are a function of the power class and the frequency band.

### SUMMARY

The present disclosure relates to methods, apparatuses, and systems that support multi-antenna panel transmission and reception. By utilizing the described techniques, aspects of the operability and coverage requirements for a communication device (e.g., a UE) are defined. Notably, the described techniques are related to reducing the testing time to evaluate a communication device for EIRP and EIS, as well as multi-panel transmission and/or multi-panel reception with one or more transmission/reception points, and taking into consideration a second-best transmission and/or reception beam as an aspect of coverage reliability, mitigating when the best beam of a device for transmission and/or reception may be blocked for signal transmission and/or signal reception.

The described techniques facilitate a reduction in testing time, particularly when evaluating a communication device (e.g., a UE) for multi-panel transmission and/or multi-panel reception with multiple TRPs, which can be time-consuming, labor intensive, complex, and expensive to perform. For example, rather than using two test probes simultaneously to measure all of the different transmission and/or reception directions around a device, a single testing probe can be utilized to capture the performance and measure all of the antenna panels for transmission and reception. The multi-panel transmission and/or multi-panel reception data can then be extracted from the single probe testing measurements, and evaluated post-processing for device performance of all of the antenna panels at the many combinations of azimuth and elevation as the performance of each antenna panel is measured over the entire sphere.

Some implementations of the method and apparatuses described herein may include wireless communication at a device (e.g., a UE), and the device includes a transceiver and a set of antenna panels. The device transmits a first signal from the transceiver via a first antenna panel to a first transmission/reception point (TRP) in a first transmission direction, and transmits a second signal from the transceiver via a second antenna panel to a second TRP in a second transmission direction. The device limits interference between the first antenna panel and the second antenna panel. The interference by the first antenna panel is limited based on the effective isotropic radiated power (EIRP) from the first antenna panel in the second transmission direction toward the second TRP. Similarly, the interference by the second antenna panel is limited based on the EIRP from the second antenna panel in the first transmission direction toward the first TRP.

In some implementations of the method and apparatuses described herein, an operability requirement of the device includes multi-panel transmission from the first antenna panel and the second antenna panel in wireless communication with the respective first and second TRPs based on a percentage of a cumulative distribution of the EIRP within a limit on the interference from the first antenna panel in the second transmission direction toward the second TRP, and from the second antenna panel in the first transmission direction toward the first TRP. To limit the interference between the first antenna panel and the second antenna panel, EIRP requirements include the EIRP of the second antenna panel in the first transmission direction subtracted from the EIRP of the first antenna panel in the first transmission direction is greater than a threshold. Similarly, the EIRP of the first antenna panel in the second transmission direction subtracted from the EIRP of the second antenna panel in the second transmission direction is greater than the threshold. The threshold is a lower bound on a signal-to-interference ratio (SIR) achievable at the first TRP and the second TRP when the first antenna panel and the second antenna panel transmit at maximum power.

Some implementations of the method and apparatuses described herein may include wireless communication at a device (e.g., a UE), and the device includes a transceiver and a set of antenna panels. The device receives a first signal from a TRP in a first reception direction via a first antenna panel, and receives a second signal from a second TRP in a second reception direction via a second antenna panel. The device limits interference between the first antenna panel and the second antenna panel. The interference by the first antenna panel is limited based on the EIS of the first antenna panel in the second reception direction of the second TRP. Similarly, the interference by the second antenna panel is limited based on the EIS of the second antenna panel in the first reception direction of the first TRP.

In some implementations of the method and apparatuses described herein, an operability requirement of the device includes multi-panel reception from the respective first and second TRPs by the first antenna panel and the second antenna panel based on a percentage of a complementary cumulative distribution of the EIS within a limit on the interference received by the first antenna panel in the second reception direction of the second TRP, and from the second antenna panel in the first reception direction of the first TRP. To limit the interference between the first antenna panel and the second antenna panel, EIS requirements include the EIS of the first antenna panel in the first reception direction subtracted from the EIS of the second antenna panel in the first reception direction is greater than a threshold. Similarly, the EIS of the second antenna panel in the second reception direction subtracted from the EIS of the first antenna panel in the second reception direction is greater than the threshold. The threshold is a lower bound on a SIR achievable at the first antenna panel and the second antenna panel when the first TRP and the second TRP transmit with a same EIRP.

Some implementations of the method and apparatuses described herein may include wireless communication at a device (e.g., a UE), and the device includes a transceiver and a set of antenna panels. The device transmits a signal from the transceiver via a best beam and a second-best beam of the set of antenna panels. The signal transmission coverage is based on a sum of the EIRP of the best beam and of the second-best beam where the second-best beam is the best beam from the set of antenna panels, excluding the antenna panel of the best beam.

In some implementations of the method and apparatuses described herein, an operability requirement of the device includes multi-panel transmission from the set of antenna panels in terms of the percentage of the cumulative distribution of the sum of the EIRP received from the best beam and the second-best beam. The signal is transmitted from two best transmission antenna panels of the set of antenna panels based at least in part on a transmission direction to a transmission-reception point (TRP) relative to the apparatus, the best beam and the second-best beam associated with the two best transmission antenna panels. A coverage reliability of the device is based on the second-best beam being the best beam from a first antenna panel of the set of antenna panels being transmitted from other than a second antenna panel corresponding to the best beam, where the coverage reliability mitigates the best beam being blocked for signal transmission.

Some implementations of the method and apparatuses described herein may include wireless communication at a device (e.g., a UE), and the device includes a transceiver and a set of antenna panels. The device receives a signal via a best beam and at least a second-best beam of the set of antenna panels. The signal reception coverage is based on combined EIS of the best beam and of the second-best beam where the second-best beam is the best beam from the set of antenna panels excluding the antenna panel of the best beam.

In some implementations of the method and apparatuses described herein, an operability requirement of the device includes multi-panel reception by the set of antenna panels in terms of the percentage of the complementary cumulative distribution of the combined EIS of the best beam and the second-best beam. The signal is received from the two best reception antenna panels of the set of antenna panels based on a reception direction to a TRP relative to the device, where the best beam and the second-best beam are associated with the two best reception antenna panels. A coverage reliability of the device is based on the second-best beam being the best beam from a first antenna panel of the set of antenna panels being received at other than a second antenna panel corresponding to the best beam, where the coverage reliability mitigates the best beam being blocked for signal reception.

### BRIEF DESCRIPTION OF THE DRAWINGS

Various aspects of the present disclosure for multi-antenna panel transmission and reception are described with reference to the following Figures. The same numbers may be used throughout to reference like features and components shown in the Figures.

FIG. 1 illustrates an example of a wireless communications system that supports multi-antenna panel transmission and reception in accordance with aspects of the present disclosure.

FIG. 2 illustrates an example of a communication device (e.g., a UE) with four antenna panels that supports multi-antenna panel transmission and reception in accordance with aspects of the present disclosure.

FIG. 3 illustrates an example of a spherical coordinate system associated with testing a communication device (e.g., a UE) that supports multi-antenna panel transmission and reception in accordance with aspects of the present disclosure.

FIG. 4 illustrates an example of a signaling diagram that supports multi-antenna panel transmission and reception in accordance with aspects of the present disclosure.

FIG. 5 illustrates an example of a signaling diagram that supports multi-antenna panel transmission and reception in accordance with aspects of the present disclosure.

FIG. 6 illustrates an example block diagram of components of a device (e.g., a UE) that supports multi-antenna panel transmission and reception in accordance with aspects of the present disclosure.

FIGS. 7-10 illustrate flowcharts of methods that support multi-antenna panel transmission and reception in accordance with aspects of the present disclosure.

### DETAILED DESCRIPTION

Implementations of multi-antenna panel transmission and reception are described, such as related to reducing the testing time to evaluate a communication device (e.g., a UE) for EIRP and EIS, as well as multi-panel transmission and/or multi-panel reception with one or more TRPs, and taking into consideration a second-best transmission and/or reception beam as an aspect of coverage reliability, mitigating when the best beam of a device for transmission and/or reception may be blocked for signal transmission and/or signal reception. By utilizing the described techniques, aspects of the operability and coverage requirements for a communication device are defined.

The described techniques facilitate a reduction in testing time, particularly when evaluating a communication device (e.g., a UE) for multi-panel transmission and/or multi-panel reception with multiple TRPs, which can be time-consuming, labor intensive, complex, and expensive to perform. For example, rather than using two test probes simultaneously to measure all of the different transmission and/or reception directions around a device, a single testing probe can be utilized to capture the performance and measure all of the antenna panels for transmission and reception. The multi-panel transmission and/or multi-panel reception data can then be extracted from the single probe testing measurements, and evaluated post-processing for device performance of all of the antenna panels at the many combinations of azimuth and elevation as the performance of each antenna panel is measured over the entire sphere. The ability of the UE to transmit and/or receive simultaneously can then be validated by simultaneous transmission and/or reception with a few combinations of azimuth/elevation pairs for the two TRPs which are controlled by the test equipment.

A communication device, such as a UE, operating in FR2 has requirements on the minimum peak EIRP that the device must achieve in at least one direction. This minimum requirement is a function of the power class and the frequency band. The other requirement that the device must achieve is a coverage requirement, which is a lower bound on the cumulative distribution function of the EIRP measured over a sphere. Specifically, the requirement is a lower bound on the EIRP that must be achieved at a specified percentile of the cumulative distribution function. The percentile that is specified depends on the power class and the corresponding device type, where the device type reflects both the form factor and the intended use of the device. Similar peak and spherical coverage requirements are defined for the EIS. However, the peak EIS is defined as an upper bound on the minimum value of the EIS in the receive beam peak direction and the coverage requirement is defined in terms of an upper bound on the complementary cumulative distribution function. Similar to the EIRP, the EIS requirements are a function of the power class and the frequency band.

A significant issue with an FR2 device (e.g., a UE) is that the signals can easily be blocked by an obstruction in front of an antenna panel of the device. Thus, even though the EIRP of the best beam in the direction of a base station (e.g., gNB) may be very good, it may often be the case that this beam is blocked by the head, hand, or body of a user of the device, or by another object. Furthermore, even if the best beam is not fully blocked, it may impinge on the user in a manner that would exceed regulatory limits for maximum permissible exposure (MPE) or specific absorption rate (SAR). As a result, the antenna panel that produces the best beam in the direction of the gNB may not be usable. For this reason, the current technique of setting the coverage requirement for a UE may not be adequate in that it does not accurately reflect the ability of the device to maintain coverage when in range of a gNB. Accordingly, aspects of the techniques described in this disclosure may be implemented to accurately reflect the ability of a device to maintain coverage and signal connection.

In addition to a device needing to maintain coverage, it is beneficial to consider the issue of multi-panel transmission and reception. Multi-panel reception can be used for a combination of increased range and/or throughput using improved receiver sensitivity, multi-input multi-output (MIMO) reception, and carrier aggregation. Similarly, multi-panel transmission can be used for a combination of increased range and/or throughput using increased transmit power, MIMO transmission, and carrier aggregation. Typically, each antenna panel in a communication device (e.g., a UE) has one set of power amplifiers for each antenna panel, where the number of power amplifiers is equal to the number of antenna elements in the antenna panel. Thus, if two panels are used to transmit simultaneously, the transmission power can be increased. Similarly, if two panels are used to receive simultaneously, the receiver sensitivity is improved because the receiver noise from the two panels is independent. In some cases, multi-panel transmission and reception may take place with the same transmission/reception point (TRP) while in other cases, the multi-panel transmission and reception may take place with multiple TRPs that are not co-located.

Aspects of the present disclosure are described in the context of a wireless communications system. Aspects of the present disclosure are further illustrated and described with reference to device diagrams and flowcharts that relate to multi-antenna panel transmission and reception.

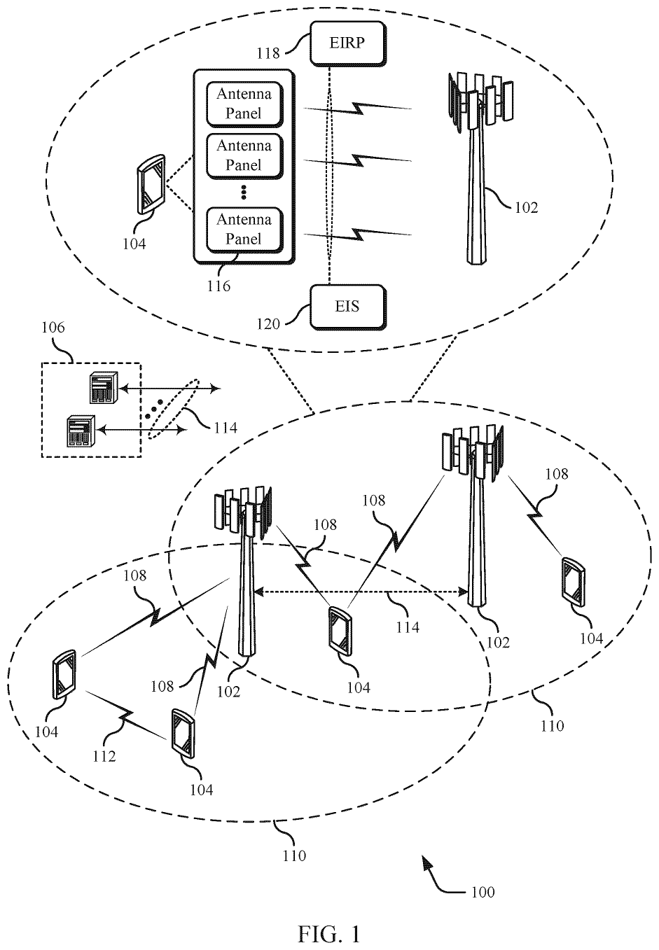

FIG. 1 illustrates an example of a wireless communications system 100 that supports multi-antenna panel transmission and reception in accordance with aspects of the present disclosure. The wireless communications system 100 may include one or more base stations 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be, or include, or may be referred to as a base transceiver station, an access point, a NodeB, an eNodeB (eNB), a next-generation NodeB (gNB), a Radio Head (RH), a relay node, an integrated access and backhaul (IAB) node, or other suitable terminology. For example, a base station 102 may be a transmission-reception point, referred to in this disclosure as TRP (not total radiated power). A base station 102 and a UE 104 may communicate via a communication link 108, which may be a wireless or wired connection. For example, a base station 102 and a UE 104 may perform wireless communication over a NR-Uu interface.

A base station 102 may provide a geographic coverage area 110 for which the base station 102 may support services (e.g., voice, video, packet data, messaging, broadcast, etc.) for one or more UEs 104 within the geographic coverage area. For example, a base station 102 and a UE 104 may support wireless communication of signals related to services (e.g., voice, video, packet data, messaging, broadcast, etc.) according to one or multiple radio access technologies. In some implementations, a base station 102 may be moveable, such as when implemented as a gNB onboard a satellite or other non-terrestrial station (NTS) associated with a non-terrestrial network (NTN). In some implementations, different geographic coverage areas 110 associated with the same or different radio access technologies may overlap, and different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region or coverage area 110 of the wireless communications system 100. A UE 104 may include or may be referred to as a mobile device, a wireless device, a remote device, a handheld device, a customer premise equipment (CPE), a subscriber device, or as some other suitable terminology. In some implementations, the UE 104 may be referred to as a unit, a station, a terminal, or a client, among other examples. Additionally, or alternatively, a UE 104 may be referred to as an Internet-of-Things (IoT) device, an Internet-of-Everything (IoE) device, or as a machine-type communication (MTC) device, among other examples. In some implementations, a UE 104 may be stationary in the wireless communications system 100. In other implementations, a UE 104 may be mobile in the wireless communications system 100, such as an earth station in motion (ESIM).

The one or more UEs 104 may be devices in different forms or having different capabilities. Some examples of UEs 104 are illustrated in FIG. 1. A UE 104 may be capable of communicating with various types of devices, such as the base stations 102, other UEs 104, or network equipment (e.g., the core network 106, a relay device, a gateway device, an integrated access and backhaul (LAB) node, a location server that implements the location management function (LMF), or other network equipment). Additionally, or alternatively, a UE 104 may support communication with other base stations 102 or UEs 104, which may act as relays in the wireless communications system 100.

A UE 104 may also support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, or other network interface). The base stations 102 may communicate with each other over the backhaul links (e.g., via an X2, Xn, or another network interface). In some implementations, the base stations 102 may communicate with each other directly (e.g., between the base stations 102). In some other implementations, the base stations 102 may communicate with each other indirectly (e.g., via the core network 106). In some implementations, one or more base stations 102 may include subcomponents, such as an access network entity, which may be an example of an access node controller (ANC). The ANC may communicate with the one or more UEs 104 through one or more other access network transmission entities, which may be referred to as remote radio heads, smart radio heads, gateways, transmission-reception points (TRPs), and other network nodes and/or entities.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)), and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to implementations, a UE 104 is operable to implement various aspects of multi-antenna panel transmission and reception, as described herein. For instance, a UE 104 includes a transceiver and a set of antenna panels 116 that are each configured to transmit and/or receive signals from a TRP (e.g., a base station 102). Notably, the wireless communications system 100 can include any number of TRPs. The UE 104 can include a processor and/or communications manager (e.g., any one or more combination of components) configured to cause the UE to transmit and/or receive one or more signals with respect to one or more TRPs.

Additionally, a processor and/or communications manager (e.g., any one or more combination of components) is configured to cause the UE 104 to transmit a signal from the transceiver, the signal transmitted simultaneously as a maximum power reference signal from a best beam in each antenna panel of the set of antenna panels for a measurement of EIRP 118 in a transmission direction. Additionally, the UE 104 can receive a reference signal and demodulate the reference signal independently for each antenna panel of the set of antenna panels for a measurement of EIS 120 in a reception direction.

Additionally, a processor and/or communications manager (e.g., any one or more combination of components) is configured to cause the UE 104 to limit interference between a first antenna panel and a second antenna panel, where the interference by the first antenna panel is limited based on the EIRP from the first antenna panel in a transmission direction toward a second TRP, and the interference by the second antenna panel is limited based on the EIRP from the second antenna panel in a transmission direction toward a first TRP. Additionally, a processor and/or communications manager (e.g., any one or more combination of components) is configured to cause the UE 104 to limit interference between the first antenna panel and the second antenna panel, where the interference by the first antenna panel is limited based on the EIS of the first antenna panel in a reception direction of the second TRP, and the interference by the second antenna panel is limited based on the EIS of the second antenna panel in the reception direction of the first TRP.

Additionally, a processor and/or communications manager (e.g., any one or more combination of components) is configured to cause the UE 104 to transmit a signal from the transceiver via a best beam and a second-best beam of the set of antenna panels, where the signal transmission coverage is based on a sum of EIRP of the best beam and of the second-best beam, which is the best beam from the set of antenna panels excluding the antenna panel of the best beam. Additionally, a processor and/or communications manager (e.g., any one or more combination of components) is configured to cause the UE 104 to receive a signal via a best beam and a second-best beam of the set of antenna panels, where the signal reception coverage is based on the combined EIS of the best beam and of the second-best beam, which is the best beam from the set of antenna panels excluding the antenna panel of the best beam.

A communication device, such as a UE, operating in FR2 has requirements on the minimum peak EIRP that the device must achieve in at least one direction. This minimum requirement is a function of the power class and the frequency band. The other requirement that the device must achieve is a coverage requirement, which is a lower bound on the cumulative distribution function of the EIRP measured over a sphere. Specifically, the requirement is a lower bound on the EIRP that must be achieved at a specified percentile of the cumulative distribution function. The percentile that is specified depends on the power class and the corresponding device type, where the device type reflects both the form factor and the intended use of the device.

The power classes and the corresponding UE types are provided as UE power class (1) for a fixed wireless access (FWA) UE; UE power class (2) for a vehicular UE; UE power class (3) for a handheld UE; UE power class (4) for a high-power non-handheld UE; and UE power class (5) for a fixed wireless access (FWA) UE. For fixed wireless access UEs (UE power classes 1 and 5), it can be assumed that the device is installed so that an antenna panel is oriented to point in the general direction of the gNB. As a result, the gain of this antenna panel in the direction of the gNB will not be much less than the peak gain of the panel. For this reason, the gNB coverage requirement is set at 85% of the cumulative distribution function of the EIRP. For the vehicular UE (power class 2), the orientation of the antenna panels relative to the vehicle can be controlled by the car manufacturer, but the orientation of the vehicle relative to the gNB is unknown. As a result, the coverage requirement is specified at 60% of the cumulative distribution function of the EIRP. For the handheld UE (power class 3), the orientation of the device relative to the gNB is unknown and as a result the coverage requirement is set at 50% of the cumulative distribution of the EIRP. Finally, for the high-power non-handheld UE (power class 4), a high level of reliability is required, and therefore the coverage requirement is specified at 20% of the cumulative distribution function of the EIRP.

Similar peak and spherical coverage requirements are defined for the EIS. However, the peak EIS is defined as a limit on the minimum value of the EIS in the receive beam peak direction and the coverage requirement is defined in terms of the complementary cumulative distribution function. Similar to the EIRP, the EIS requirements are a function of the power class and the frequency band. For the spherical coverage requirements, the percentile values are the same as for the EIRP—that is, the percentile requirements are 85%, 60%, 50%, 20%, and 85% for the respective power classes 1, 2, 3, 4, and 5 (as described above).

The EIRP spherical coverage requirements for the different power classes (as indicated in TS 38.101-1) are shown in the tables T1-T5 below:

TABLE T1
UE Spherical Coverage for Power Class 1

| Operating band | Min EIRP at 85%-tile CDF (dBm) |
|---|---|
| n257 | 32.0 |
| n258 | 32.0 |
| n260 | 30.0 |
| n261 | 32.0 |
| n262 | 26.0 |

NOTE 1:
Minimum EIRP at 85%-tile CDF is defined as the lower limit without tolerance
NOTE 2:
The requirements in this table are verified only under normal temperature conditions as defined in Annex E.2.1.

TABLE T2
UE Spherical Coverage for Power Class 2

| Operating band | Min EIRP at 60%-tile CDF (dBm) |
|---|---|
| n257 | 18.0 |
| n258 | 18.0 |
| n261 | 18.0 |
| n262 | 11.0 |

NOTE 1:
Minimum EIRP at 60%-tile CDF is defined as the lower limit without tolerance
NOTE 2:
The requirements in this table are verified only under normal temperature conditions as defined in Annex E.2.1.

TABLE T3
UE Spherical Coverage for Power Class 3

| Operating band | Min EIRP at 50%-tile CDF (dBm) |
|---|---|
| n257 | 11.5 |
| n258 | 11.5 |
| n259 | 5.8 |
| n260 | 8 |
| n261 | 11.5 |
| n262 | 2.9 |

NOTE 1:
Minimum EIRP at 50%-tile CDF is defined as the lower limit without tolerance
NOTE 2:
Void
NOTE 3:
The requirements in this table are verified only under normal temperature conditions as defined in Annex E.2.1.

TABLE T4
UE Spherical Coverage for Power Class 4

| Operating band | Min EIRP at 20%-tile CDF (dBm) |
|---|---|
| n257 | 25 |
| n258 | 25 |
| n260 | 19 |
| n261 | 25 |
| n262 | 16.2 |

NOTE 1:
Minimum EIRP at 20%-tile CDF is defined as the lower limit without tolerance
NOTE 2:
The requirements in this table are verified only under normal temperature conditions as defined in Annex E.2.1.

TABLE T5
UE Spherical Coverage for Power Class 5

| Operating band | Min EIRP at 85%-tile CDF (dBm) |
|---|---|
| n257 | 22 |
| n258 | 22.4 |
| n259 | 19.7 |

NOTE 1:
Minimum EIRP at 85%-tile CDF is defined as the lower limit without tolerance
NOTE 2:
The requirements in this table are verified only under normal temperature conditions as defined in Annex E.2.1.

The EIS spherical coverage requirements for the different power classes (as indicated in TS 38.101-2) are shown in the tables T6-T10 below:

TABLE T6
EIS Spherical Coverage for Power Class 1

| Operating | EIS at 85^{th} %-tile CCDF (dBm)/Channel bandwidth | | | |
|---|---|---|---|---|
| band | 50 MHz | 100 MHz | 200 MHz | 400 MHz |
| n257 | −89.5 | −86.5 | −83.5 | −80.5 |
| n258 | −89.5 | −86.5 | −83.5 | −80.5 |
| n260 | −86.5 | −83.5 | −80.5 | −77.5 |
| n261 | −89.5 | −86.5 | −83.5 | −80.5 |
| n262 | −84.3 | −81.3 | −78.3 | −75.3 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T7
EIS Spherical Coverage for Power Class 2

| Operating | EIS at 60^{th} %-tile CCDF (dBm)/Channel bandwidth | | | |
|---|---|---|---|---|
| band | 50 MHz | 100 MHz | 200 MHz | 400 MHz |
| n257 | −81.0 | −78.0 | −75.0 | −72.0 |
| n258 | −81.0 | −78.0 | −75.0 | −72.0 |
| n261 | −81.0 | −78.0 | −75.0 | −72.0 |
| n262 | −74.9 | −71.9 | −68.9 | −65.9 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T8
EIS Spherical Coverage for Power Class 3

| Operating | EIS at 50^{th} %-tile CCDF (dBm)/Channel bandwidth | | | |
|---|---|---|---|---|
| band | 50 MHz | 100 MHz | 200 MHz | 400 MHz |
| n257 | −77.4 | −74.4 | −71.4 | −68.4 |
| n258 | −77.4 | −74.4 | −71.4 | −68.4 |
| n259 | −71.9 | −68.9 | −65.9 | −62.9 |
| n260 | −73.1 | −70.1 | −67.1 | −64.1 |
| n261 | −77.4 | −74.4 | −71.4 | −68.4 |
| n262 | −69.7 | −66.7 | −63.7 | −60.7 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T9
EIS Spherical Coverage for Power Class 4

| Operating | EIS at 20^{th} %-tile CCDF (dBm)/Channel bandwidth | | | |
|---|---|---|---|---|
| band | 50 MHz | 100 MHz | 200 MHz | 400 MHz |
| n257 | −88.0 | −85.0 | −82.0 | −79.0 |
| n258 | −88.0 | −85.0 | −82.0 | −79.0 |
| n260 | −83.0 | −80.0 | −77.0 | −74.0 |
| n261 | −88.0 | −85.0 | −82.0 | −79.0 |
| n262 | −78.9 | −75.9 | −72.9 | −69.9 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

TABLE T10
EIS Spherical Coverage for Power Class 5

| Operating | EIS at 85^{th} %-tile CCDF (dBm)/Channel bandwidth | | | |
|---|---|---|---|---|
| band | 50 MHz | 100 MHz | 200 MHz | 400 MHz |
| n257 | −84.6 | −81.6 | −78.6 | −75.6 |
| n258 | −84.8 | −81.8 | −78.8 | −75.8 |
| n259 | −81.7 | −78.7 | −75.7 | −72.7 |

NOTE 1:
The transmitter shall be set to P_{UMAX} as defined in clause 6.2.4
NOTE 2:
The EIS spherical coverage requirements are verified only under normal thermal conditions as defined in Annex E.2.1.

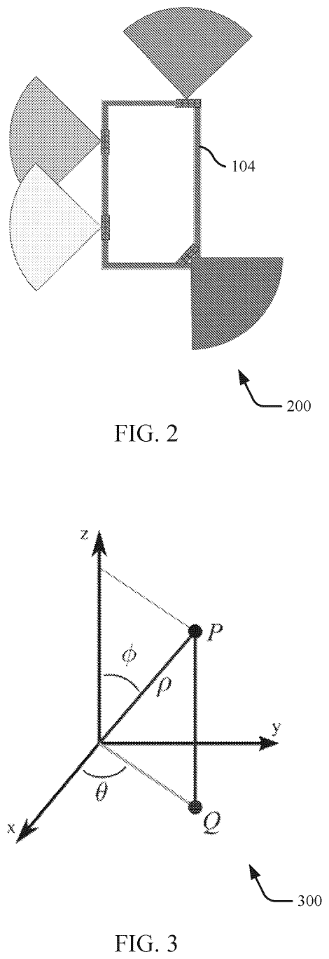

FIG. 2 illustrates an example 200 of a communication device (e.g., a UE 104) with four antenna panels, as related to multi-antenna panel transmission and reception. Each antenna panel of the device is comprised of multiple antenna elements which can be dipole antennas, patch antennas, or other types of antenna elements. Each antenna element can have a single polarization or dual polarizations. The antenna elements comprising an antenna array can have uniform spacing, such as half wavelength spacing. The antenna elements can be configured as a linear array, such as in a 1×8 array with eight antenna elements in a single dimension, or as a rectangular array, such as a 2×4 array with two antenna elements in a first dimension and four antenna elements in a second dimension for a total of eight antenna elements.

For handheld devices (e.g., a UE), it can be assumed that each device will have at least two antenna panels. In order to evaluate the coverage reliability and redundancy for the device, the cumulative distribution of the second-best beam is considered for each azimuth and elevation, where the second-best beam must be from an antenna panel that is different than the antenna panel that is used to source the best beam. The cumulative distribution of the second-best beam indicates the coverage that is achievable when the best beam is either blocked or cannot be used due to MPE or SAR regulations. It should be noted that the panel used for the best beam and the panel used for the second-best beam will depend on the direction of measurement (azimuth and elevation) relative to the device.

A test and measurement mode of operation can be defined for a communication device (e.g., a UE) for measurement of the EIRP with the following designated characteristics. The UE scans for the synchronization system block (SSB) or other reference signal using each of its antenna panels. Depending on the UE capability, the UE may scan for the SSB on the antenna panels sequentially or in parallel. If the UE scans for the SSB on the antenna panels sequentially, the UE scans all of the beams on the first panel prior to scanning any of the beams on the second panel. If the UE has the capability to scan for the SSB on the antenna panels simultaneously, then the UE can scan beams for each antenna panel independently. Additionally, the UE indicates to the test equipment which antenna panels have a beam that can be used to demodulate the PBCH independently of the other panels.

Further, for each antenna panel that can demodulate the PBCH, the UE transmits a known reference signal using the best beam from that antenna panel. The reference signal is transmitted at maximum power. It can be noted that separate power amplifiers are used for each antenna panel, so that the single beam from each panel can be transmitted at full power. The test equipment measures the power of the received reference signal to determine the EIRP for the given azimuth and elevation (relative to the UE) for each antenna panel. The UE can be assigned different frequency resources (resource blocks) for each antenna panel's transmission so that the test equipment can measure the EIRP for the best beam from each antenna panel independently without the transmissions interfering with each other. If receiver blocking is a concern so that a weak signal adjacent in frequency to a strong signal may be lost due to dynamic range limitations, then the test equipment can instruct the UE to transmit on the best beams of the antenna panels sequentially using the same frequency resources.

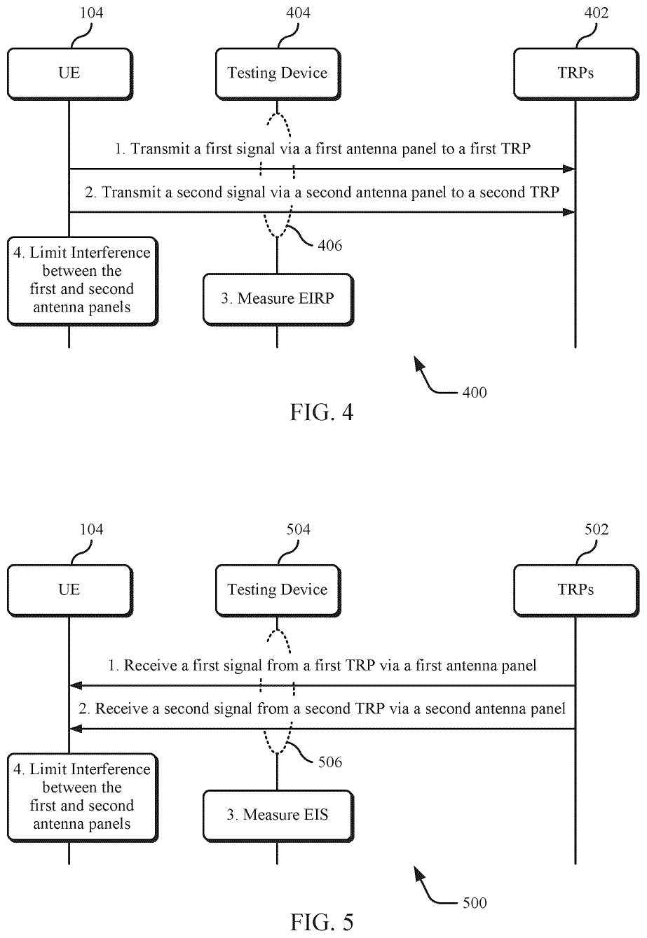

FIG. 3 illustrates an example 300 of a spherical coordinate system associated with testing a communication device (e.g., a UE 104), as related to multi-antenna panel transmission and reception. With reference to test setups, a transmit/receive test probe may be rotated in azimuth and elevation about a device that is being tested. Alternatively, the transmit/receive test probe may be fixed in position, and the device that is being tested is rotated in azimuth and elevation about the test probe. In either case, the testing integrates over the unit sphere with a radius equal to one (1).

During the EIRP test and measurement, the test equipment records the EIRP, EIRPᵢ(θⱼ,ϕⱼ) for each panel i, 1≤i≤P, where P is the number of antenna panels on the device, and for a set of azimuth and elevation angles (θⱼ,ϕⱼ), 0≤θⱼ<2π, 0≤ϕⱼ<π that cover the unit sphere. The measurements are taken over a set of points on a sphere centered on the device under test (e.g., the UE) with sufficient granularity to achieve the required measurement accuracy and uncertainty. The measurement points are defined with respect to their azimuth and elevation relative to the UE. The measurement points may be uniformly spaced or not, but the weight applied to each measurement when determining the cumulative distribution function or the complementary cumulative distribution function should reflect the area on the sphere that is closer to the measurement point than to any other measurement point as measured in steradians.

While taking the EIRP measurements as described above, the test equipment collects the following statistics:
1) The cumulative distribution of the best beam power received from the first antenna panel.
2) The cumulative distribution of the best beam power received from the second antenna panel.
3) The cumulative distribution of the best beam power received from the n-th antenna panel.
4) The peak power received from the first antenna panel taken over all beams and all azimuths and elevations.
5) The peak power received from the second antenna panel taken over all beams and all azimuths and elevations.
6) The peak power received from the n-th antenna panel taken over all beams and all azimuths and elevations.
7) The azimuth and elevation of the peak power of the first antenna panel.
8) The azimuth and elevation of the peak power of the second antenna panel.
9) The azimuth and elevation of the peak power of the n-th antenna panel.
10) The cumulative distribution of the power received from the best beam taken over all of the UE antenna panels.
11) The cumulative distribution of the power received from the second-best beam, where the second-best beam is the best beam taken over all of the antenna panels excluding the antenna panel of the best beam.
12) The cumulative distribution of the power received from the n-th best beam, where the n-th best beam is the best beam taken over all of the antenna panels excluding the antenna panels corresponding to the best beams up to and including the n−1-st best beam.
13) The cumulative distribution of the sum of the power received from the best beam taken over all of the antenna panels and the second-best beam, where the second-best beam is the best beam taken over all antenna panels excluding the antenna panel of the best beam and the combined power is given by:

$${EIRP}_{C} ( {θ}_{j} , {ϕ}_{j} ) = {EIRP}_{1} ( {θ}_{j} , {ϕ}_{j} ) + {EIRP}_{2} ( {θ}_{j} , {ϕ}_{j} )$$

14) The cumulative distribution of the sum of the power received on the best n beams where the j-th best beam is the best beam taken over all of the antenna panels excluding panels corresponding to the beams up to and including the j−1-st best beam and the combined power is given by:

$$E I R {P}_{c} ( {θ}_{j} , {ϕ}_{j} ) = E I R {P}_{1} ( {θ}_{j} , {ϕ}_{j} ) + E I R {P}_{2} ( {θ}_{j} , {ϕ}_{j} ) + … + E I R {P}_{n} ( {θ}_{j} , {ϕ}_{j} )$$

A test and measurement mode of operation can be defined for a communication device (e.g., a UE) for determining the EIS with the following designated characteristics. The UE scans for the SSB or other reference signal using each of its antenna panels. Depending on the UE capability, the UE may scan for the SSB on the antenna panels sequentially or in parallel. If the UE scans for the SSB on the antenna panels sequentially, the UE scans all of the beams on the first panel prior to scanning any of the beams on the second panel. If the UE has the capability to scan for the SSB on the antenna panels simultaneously, then the UE can scan beams for each antenna panel independently. Additionally, the UE indicates to the test equipment which antenna panels have a beam that can be used to demodulate the PBCH independently of the other panels. The test equipment transmits a reference signal to the UE at a first power level.

Using the best beam at each antenna panel, the UE attempts to demodulate the reference signal. The beams are not combined prior to demodulation. Depending on the UE capability, the UE may demodulate the reference signal on the best beams of the UE antenna panels sequentially or in parallel. The UE determines the error rate for the demodulated test signal. Further, the UE indicates for each antenna panel whether or not the error rate exceeded the threshold defined for reference sensitivity. If the error rate was not exceeded for at least one antenna panel, the test equipment transmits the reference signal to the UE at a power level that is less than the first power level. The reference sensitivity for each antenna panel is the minimum power for which the reference signal is demodulated with an error rate less than the threshold defined for reference sensitivity.

During the EIS test and measurement, the test equipment records the EIS, EISᵢ(θⱼ,ϕⱼ) for each panel i, 1≤i≤P, where P is the number of antenna panels on the device, and for a set of azimuth and elevation angles (θⱼ,ϕⱼ), 0≤θⱼ<2π, 0≤ϕⱼ<π that cover the unit sphere. The measurements are taken over a set of points on a sphere centered on the device under test (e.g., the UE) with sufficient granularity to achieve the required measurement accuracy and uncertainty. The measurement points are defined with respect to their azimuth and elevation relative to the UE. The measurement points may be uniformly spaced or not, but the weight applied to each measurement when determining the cumulative distribution function or the complementary cumulative distribution function should reflect the area on the sphere that is closer to the measurement point than to any other measurement point as measured in steradians.

While taking the EIS measurements as described above, the test equipment collects the following statistics:
1) The complementary cumulative distribution of the best beam EIS for the first antenna panel.
2) The complementary cumulative distribution of the best beam EIS for the second antenna panel.
3) The complementary cumulative distribution of the best beam EIS for the n-th antenna panel.
4) The minimum EIS for the first antenna panel taken over all beams and all azimuths and elevations.
5) The minimum EIS for the second antenna panel taken over all azimuths and elevations.
6) The minimum EIS for the n-th antenna panel taken over all azimuths and elevation.
7) The azimuth and elevation of the minimum EIS of the first antenna panel.
8) The azimuth and elevation of the minimum EIS of the second antenna panel.
9) The azimuth and elevation of the minimum EIS of the n-th antenna panel.
10) The complementary cumulative distribution of best beam EIS taken over all of the antenna panels.
11) The complementary cumulative distribution of the EIS of the second-best beam where the second-best beam is the best beam taken over all of the antenna panels excluding the antenna panel of the best beam.
12) The complementary cumulative distribution of the EIS of the n-th best beam where the n-th best beam is the best beam taken over all of the antenna panels excluding the antenna panels corresponding to the best beams up to and including the n−1-st best beam.
13) The cumulative distribution of the combined EIS of the best beam taken over all of the antenna panels and the second-best beam where the second-best beam is the best beam taken over all of the antenna panels excluding the panels corresponding to the best beam, where the combined EIS is given by:

$$E I {S}_{c} ( {θ}_{j} , {ϕ}_{j} ) = {( \frac{1}{E I {S}_{1} ( {θ}_{j} , {ϕ}_{j} )} + \frac{1}{E I {S}_{2} ( {θ}_{j} , {ϕ}_{j} )} )}^{- 1}$$

14) The cumulative distribution of the combined EIS of the n best beams taken over all of the antenna panels, where the j-th best beam is the best beam taken over all of the antenna panels excluding panels corresponding to the beams up to and including the j−1-st best beam, and where the combined EIS is given by:

$$E I {S}_{c} ( {θ}_{j} , {ϕ}_{j} ) = {( \frac{1}{E I {S}_{1} ( {θ}_{j} , {ϕ}_{j} )} + \frac{1}{E I {S}_{2} ( {θ}_{j} , {ϕ}_{j} )} + … + \frac{1}{E I {S}_{n} ( {θ}_{j} , {ϕ}_{j} )} )}^{- 1}$$

In order to address reducing the typical measurement time required to take the EIRP and EIS measurements for a communication device (e.g., a UE) that has multiple antenna panels, innovative test modes are described in this disclosure. For the EIRP measurement, after determining the best beam for each panel for a given azimuth and elevation from the SSB, the UE transmits a reference signal with maximum power on the best beam for each antenna panel. The UE can be assigned different frequency resources (resource blocks) for each antenna panel's transmission so that the test equipment can measure the EIRP for the best beam from each antenna panel independently without the transmissions interfering with each other. For the EIS measurement, after determining the best beam for each panel for a given azimuth and elevation using the received SSB, the UE receives a reference signal from the test equipment and demodulates the reference signal independently for each antenna panel using the best beam. The UE indicates for each power level and each antenna panel whether or not the error rate exceeded the threshold defined for reference sensitivity.

When defining coverage requirements with multi-panel transmission and reception, there are primarily two cases that are taken into consideration. Notably, multi-panel requirements for a single transmission/reception point (TRP), and multi-panel requirements for two or more TRPs. In the case of the multi-panel requirements for two or more TRPs, each antenna panel transmits to and receives from a single transmission point, which is different from the TRPs from which the other antenna panels transmit and receive. Coverage requirements are considered for each of these two cases.

With respect to multi-panel, single-TRP coverage requirements, the combined EIRP, EIRP_{C}(θ,ϕ), and the combined EIS, EIS_{C}(θ,ϕ), described above in the respective steps 13 for the EIRP and EIS measurements, reflect the combined EIRP and EIS when a communication device (e.g., a UE) is using the two best panels to transmit to and receive from a single TRP. It should be noted that the two best panels will depend on the direction (θ,ϕ) of the TRP relative to the UE.

For the multi-panel, single-TRP EIS coverage requirement, for a given EIS value a, the region A(a) of coverage can be defined as:

$$A ( a ) = \{ ( θ , ϕ ) : {EIS}_{i} ( θ , ϕ ) \leq a \}$$

for some index i, 1≤i≤P, and P is the number of antenna panels on the device. With this definition, the complementary cumulative distribution function of the EIS is given by:

$$CCDF ( a ) = 1 - \frac{1}{4 π} {\int }_{θ = 0}^{2 π} {\int }_{ϕ = 0}^{π} {I}_{A ( a )} ( θ , ϕ ) sin ϕ d ϕ d θ$$

where I_{A(a)}(θ,ϕ) is the indicator function given by:

$${I}_{A ( a )} ( θ , ϕ ) = \{ \begin{matrix}1 & ( θ , ϕ ) ∈ A ( a ) \\ 0 & else\end{matrix}$$

For the multi-panel, single-TRP EIRP coverage requirement, for a given EIRP value a, the region B(a) of coverage can be defined as:

$$B ( a ) = \{ ( θ , ϕ ) : {EIRP}_{i} ( θ , ϕ ) \leq a \}$$

for some index i, 1≤i≤P, and P is the number of antenna panels on the device. With this definition, the cumulative distribution function of the EIRP is given by:

$$C D F ( a ) = \frac{1}{4 π} {\int }_{θ = 0}^{2 π} {\int }_{ϕ = 0}^{π} {I}_{B ( a )} ( θ , ϕ ) sin ϕ d ϕ d θ$$

where I_{A(a)}(θ,ϕ) is the indicator function given by:

$${I}_{B ( a )} ( θ , ϕ ) = \{ \begin{matrix}1 & ( θ , ϕ ) ∈ B ( a ) \\ 0 & else\end{matrix}$$

With respect to multi-panel, multi-TRP coverage requirements, it is needed to consider the case when two or more antenna panels are connected to different transmission points. In this case, it is assumed that each antenna panel is in direct communication with at most one transmission point. If the first antenna panel is connected to the first TRP in direction (θ₁,ϕ₁), and if the second antenna panel is connected to a second TRP in direction (θ₂,ϕ₂), then the following two requirements are needed to limit interference between the two antenna panels and the two transmission points.

First, for the EIRP requirements:

$$\begin{matrix}{EIRP}_{1} ( {θ}_{1} , {ϕ}_{1} ) - {EIRP}_{2} ( {θ}_{1} , {ϕ}_{1} ) > {t}_{1} \\ and \\ {EIRP}_{2} ( {θ}_{2} , {ϕ}_{2} ) - {EIRP}_{1} ( {θ}_{2} , {ϕ}_{2} ) > {t}_{1} ,\end{matrix}$$

where the threshold t₁ is a lower bound on the SIR that is achievable at the first and second TRPs when the panels are transmitting at maximum power.

Second, for the EIS requirements:

$$\begin{matrix}EI {S}_{2} ( {θ}_{1} , {ϕ}_{1} ) - E I {S}_{1} ( {θ}_{1} , {ϕ}_{1} ) > {t}_{2} \\ and \\ {EIS}_{1} ( {θ}_{2} , {ϕ}_{2} ) - E I {S}_{2} ( {θ}_{2} , {ϕ}_{2} ) > {t}_{2} ,\end{matrix}$$

where the threshold t₂ is a lower bound on the SIR that is achievable at the first and second antenna panels when TRPs are transmitting with the same EIRP in the direction of the device.

With respect to multi-panel, multi-TRP for EIS coverage, for a given EIS value a and for a given lower bound on the achievable signal-to-interference ratio achievable on both panels t, the region A(a,t) of dual panel coverage can be defined as:

$$A ( a , t ) = \{ \begin{matrix}( {θ}_{1} , {ϕ}_{1} , {θ}_{2} , {ϕ}_{2} ) : {EIS}_{i} ( {θ}_{1} , {ϕ}_{1} ) \leq a , {EIS}_{j} ( {θ}_{2} , {ϕ}_{2} ) \leq a , \\ EI {S}_{j} ( {θ}_{1} , {ϕ}_{1} ) - {EIS}_{i} ( {θ}_{1} , {ϕ}_{1} ) > t , and \\ {EIS}_{i} ( {θ}_{2} , {ϕ}_{2} ) - {EIS}_{j} ( {θ}_{2} , {ϕ}_{2} ) > t\end{matrix} \}$$

for some indices i≠j, 1≤i≤P, 1≤j≤P and P is the number of antenna panels on the device. With this definition, the complementary cumulative distribution function for dual-panel EIS coverage is given by:

$$CCDF ( a , t ) = 1 - \frac{1}{16 {π}^{2}} {\int }_{{θ}_{1} = 0}^{2 π} {\int }_{{ϕ}_{1} = 0}^{π} {\int }_{{θ}_{2} = 0}^{2 π} {\int }_{{ϕ}_{2} = 0}^{π} {I}_{A ( a , t )} ( {θ}_{1} , {ϕ}_{1} , {θ}_{2} , {ϕ}_{2} ) sin {ϕ}_{2} sin {ϕ}_{1} d {∅}_{2} d {θ}_{2} d {∅}_{1} d {θ}_{1}$$

where I_{A(a,t)}(θ₁,ϕ₁,θ₂,ϕ₂) is the indicator function given by:

$${I}_{A ( a , t )} ( {θ}_{1} , {ϕ}_{1} , {θ}_{2} , {ϕ}_{2} ) = \{ \begin{matrix}1 & ( {θ}_{1} , {ϕ}_{1} , {θ}_{2} , {ϕ}_{2} ) ∈ A ( a , t ) \\ 0 & else\end{matrix}$$

and it can be noted that this is a complementary cumulative distribution function in two parameters with:

$${lim}_{a \to ∞ , t \to - ∞} CCDF ( a , t ) = 0$$

With respect to multi-panel, multi-TRP for EIRP coverage, for a given EIRP value equal to a and for a given lower bound on the achievable signal-to-interference ratio achievable on both panels t, the region B(a,t) of dual panel coverage can be defined as:

$$B ( a , t ) = \{ \begin{matrix}( {θ}_{1} , {ϕ}_{1} , {θ}_{2} , {ϕ}_{2} ) : {EIRP}_{i} ( {θ}_{1} , {ϕ}_{1} ) \leq a , {EIRP}_{j} ( {θ}_{2} , {ϕ}_{2} ) \leq a , \\ {EIRP}_{i} ( {θ}_{1} , {ϕ}_{1} ) - {EIRP}_{j} ( {θ}_{1} , {ϕ}_{1} ) > t , and \\ {EIRP}_{j} ( {θ}_{2} , {ϕ}_{2} ) - {EIRP}_{i} ( {θ}_{2} , {ϕ}_{2} ) > t\end{matrix} \}$$

for some indices i≠j, 1≤i≤P, 1≤j≤P and P is the number of antenna panels on the device. With this definition, the cumulative distribution function for dual-panel EIRP coverage is given by:

$$CDF ( a , t ) = \frac{1}{16 {π}^{2}} {\int }_{{θ}_{1} = 0}^{2 π} {\int }_{{ϕ}_{1} = 0}^{π} {\int }_{{θ}_{2} = 0}^{2 π} {\int }_{{ϕ}_{2} = 0}^{π} {I}_{B ( a , t )} ( {θ}_{1} , {ϕ}_{1} , {θ}_{2} , {ϕ}_{2} ) sin {ϕ}_{2} sin {ϕ}_{1} d {∅}_{2} d {θ}_{2} d {∅}_{1} d {θ}_{1}$$

where I_{B(a,t)}(θ₁,ϕ₁,θ₂,ϕ₂) is the indicator function given by:

$${I}_{B ( a , t )} ( {θ}_{1} , {ϕ}_{1} , {θ}_{2} , {ϕ}_{2} ) = \{ \begin{matrix}1 & ( {θ}_{1} , {ϕ}_{1} , {θ}_{2} , {ϕ}_{2} ) ∈ B ( a , t ) \\ 0 & else\end{matrix}$$

and it can be noted that this is a cumulative distribution function in two parameters with:

$${lim}_{a \to ∞ , t \to - ∞} C D F ( a , t ) = 1$$

As discussed above, the best antenna panel may often be blocked by the hand, head, or body of a user of the device, or by another object so that it cannot be used. Thus, it is beneficial to consider coverage reliability in terms of the second-best beam, where the second-best beam is required to be from an antenna panel other than the antenna panel corresponding to the best beam. Let s denote the index of the antenna panel corresponding to the second-best beam and let EIRPₛ(θ,ϕ) and EISₛ(θ,ϕ) respectively, denote the EIRP and EIS in the direction (θ,ϕ). It should be noted that the second-best panel will be a function of the direction (θ,ϕ) of the gNB or TRP relative to the UE. With these definitions, the coverage requirements can be defined in terms of the complementary cumulative distribution function of the EIS and the cumulative distribution function of the EIRP.

With respect to the second-best panel for EIS coverage, for a given EIS value a, the region A(a) of coverage can be defined as:

$$A ( a ) = \{ ( θ , ϕ ) : E I {S}_{S} ( θ , ϕ ) \leq a \}$$

where s is the index 1≤s≤P of the second-best antenna panel (with second lowest EIS value) in the direction (θ,ϕ), and P is the number of antenna panels on the device. With this definition, the complementary cumulative distribution function for EIS coverage with the second-best antenna panel is given by:

$$CCDF ( a ) = 1 - \frac{1}{4 π} {\int }_{θ = 0}^{2 π} {\int }_{ϕ = 0}^{π} {I}_{A ( a )} ( θ , ϕ ) sin ϕ d ϕ d θ$$

where I_{A(a)}(θ,ϕ) is the indicator function given by:

$${I}_{A ( a )} ( θ , ϕ ) = \{ \begin{matrix}1 & ( θ , ϕ ) ∈ A ( a ) \\ 0 & else\end{matrix}$$

With respect to the second-best panel for EIRP coverage, for a given EIRP value a, the region B(a) of coverage can be defined as:

$$B ( a ) = \{ ( θ , ϕ ) : {EIRP}_{S} ( θ , ϕ ) \leq a \}$$

where s is the index 1≤s≤P of the second-best antenna panel (with second highest EIRP) in the direction (θ,ϕ), and P is the number of antenna panels on the device. With this definition, the cumulative distribution function for EIRP coverage with the second-best antenna panel is given by:

$$C D F ( a ) = \frac{1}{4 π} {\int }_{θ = 0}^{2 π} {\int }_{ϕ = 0}^{π} {I}_{B ( a )} ( θ , ϕ ) sin ϕ d ϕ d θ$$

where I_{B(a)}(θ,ϕ) is the indicator function given by:

$${I}_{B ( a )} ( θ , ϕ ) = \{ \begin{matrix}1 & ( θ , ϕ ) ∈ B ( a ) \\ 0 & else\end{matrix}$$

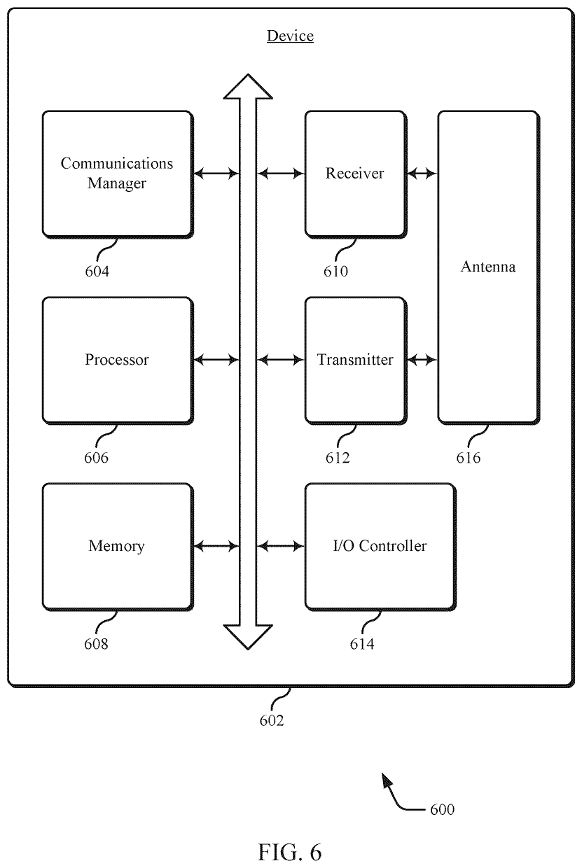

FIG. 4 illustrates an example of a signaling diagram that supports multi-antenna panel transmission and reception in accordance with aspects of the present disclosure. A communication device (e.g., a UE 104) includes at least a transceiver and a set of antenna panels. The UE 104 transmits (at step 1) a first signal from the transceiver via a first antenna panel to a first TRP 402 in a first transmission direction. The UE also transmits (at step 2) a second signal from the transceiver via a second antenna panel to a second TRP 402 in a second transmission direction. A testing device 404 receives (at 406) the first and second signals transmitted from the UE 104 to the TRPs 402, and measures (at step 3) the EIRP. The UE 104 limits interference (at step 4) between the first antenna panel and the second antenna panel. The interference by the first antenna panel is limited based on the EIRP from the first antenna panel in the second transmission direction toward the second TRP. Similarly, the interference by the second antenna panel is limited based on the EIRP from the second antenna panel in the first transmission direction toward the first TRP. Although the UE 104 and the testing device 404 are illustrated and described as separate devices and/or components, the testing device or comparable logic may be integrated with the UE.

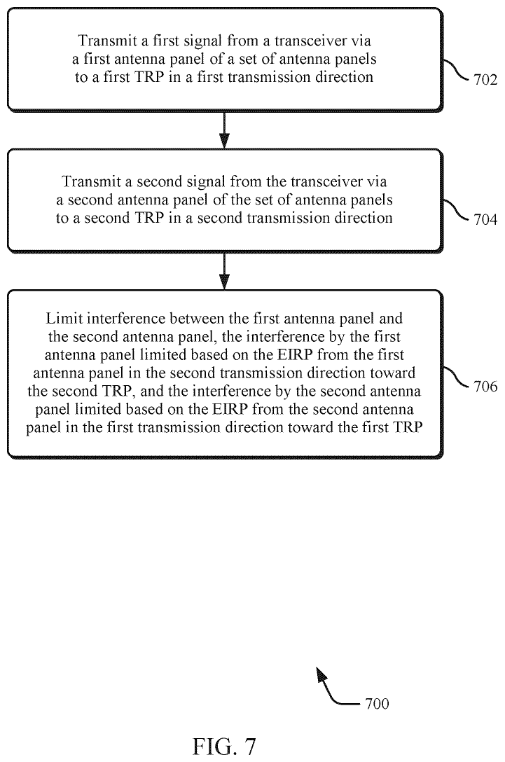

FIG. 5 illustrates an example of a signaling diagram that supports multi-antenna panel transmission and reception in accordance with aspects of the present disclosure. A communication device (e.g., a UE 104) includes at least a transceiver and a set of antenna panels. The UE 104 receives (at step 1) a first signal from a first TRP 502 in a first reception direction via a first antenna panel. The UE also receives (at step 2) a second signal from a second TRP 502 in a second reception direction via a second antenna panel. A testing device 504 controls (at 506) the first and second signals transmitted from the TRPs 502 to the UE 104, and based on the EIRP of the TRPs in the direction of the UE, determines (at step 3) the EIS. The UE 104 limits interference (at step 4) between the first antenna panel and the second antenna panel. The interference by the first antenna panel is limited based on the EIS of the first antenna panel in the second reception direction of the second TRP. Similarly, the interference by the second antenna panel is limited based on the EIS of the second antenna panel in the first reception direction of the first TRP. Although the UE 104 and the testing device 504 are illustrated and described as separate devices and/or components, the testing device or comparable logic may be integrated with the UE.

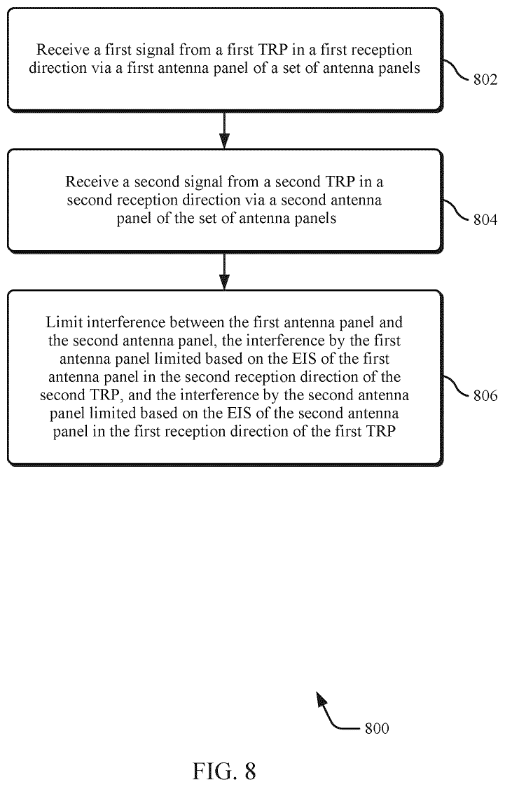

FIG. 6 illustrates an example of a block diagram 600 of a device 602 that supports multi-antenna panel transmission and reception in accordance with aspects of the present disclosure. The device 602 may be an example of a UE 104 as described herein. The device 602 may support wireless communication and/or network signaling with one or more base stations 102, other UEs 104, network entities and devices, or any combination thereof. The device 602 may include components for bi-directional communications including components for transmitting and receiving communications, such as a communications manager 604, a processor 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses).

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication and/or network signaling at a device (e.g., the device 602, a UE) in accordance with examples as disclosed herein. The communications manager 604 and/or other device components may be configured as or otherwise support an apparatus, such as a UE, including a transceiver; a set of antenna panels; a processor coupled to the transceiver, the processor and the transceiver configured to cause the apparatus to: transmit a first signal from the transceiver via a first antenna panel of the set of antenna panels to a first TRP in a first transmission direction; transmit a second signal from the transceiver via at least a second antenna panel of the set of antenna panels to a second TRP in a second transmission direction; and limit interference between the first antenna panel and the second antenna panel, the interference by the first antenna panel limited based at least in part on EIRP from the first antenna panel in the second transmission direction toward the second TRP, and the interference by the second antenna panel limited based at least in part on the EIRP from the second antenna panel in the first transmission direction toward the first TRP.

Additionally, the apparatus (e.g., a UE) includes any one or combination of: an operability requirement of the apparatus comprises multi-panel transmission from the first antenna panel and the second antenna panel in wireless communication with the respective first and second TRPs based at least in part on a percentage of a cumulative distribution of the EIRP within a limit on the interference from the first antenna panel in the second transmission direction toward the second TRP, and from the second antenna panel in the first transmission direction toward the first TRP. To limit the interference between the first antenna panel and the at least second antenna panel, EIRP requirements comprise: the EIRP of the second antenna panel in the first transmission direction subtracted from the EIRP of the first antenna panel in the first transmission direction is greater than a threshold; and the EIRP of the first antenna panel in the second transmission direction subtracted from the EIRP of the second antenna panel in the second transmission direction is greater than the threshold. The threshold is a lower bound on a signal-to-interference ratio (SIR) achievable at the first TRP and the second TRP when the first antenna panel and the second antenna panel transmit at maximum power. To limit the interference between the first antenna panel and the at least second antenna panel, EIRP requirements comprise: EIRP₁(θ₁,ϕ₁)−EIRP₂(θ₁,ϕ₁)>t₁ and EIRP₂(θ₂,ϕ₂)−EIRP₁(θ₂,ϕ₂)>t₁. The threshold t₁ is a lower bound on a SIR achievable at the first TRP and the second TRP when the first antenna panel and the second antenna panel transmit at maximum power.

The communications manager 604 and/or other device components may be configured as or otherwise support a means for wireless communication and/or network signaling at a UE, including transmitting a first signal from a transceiver via a first antenna panel of a set of antenna panels to a first TRP in a first transmission direction; transmitting a second signal from the transceiver via at least a second antenna panel of the set of antenna panels to a second TRP in a second transmission direction; and limiting interference between the first antenna panel and the second antenna panel, the interference by the first antenna panel limited based at least in part on EIRP from the first antenna panel in the second transmission direction toward the second TRP, and the interference by the second antenna panel limited based at least in part on the EIRP from the second antenna panel in the first transmission direction toward the first TRP.

Additionally, wireless communication and/or network signaling at the UE includes any one or combination of: an operability requirement comprises multi-panel transmission from the first antenna panel and the second antenna panel in wireless communication with the respective first and second TRPs based at least in part on a percentage of a cumulative distribution of the EIRP within a limit on the interference from the first antenna panel in the second transmission direction toward the second TRP, and from the second antenna panel in the first transmission direction toward the first TRP. The limiting interference between the first antenna panel and the at least second antenna panel, EIRP requirements comprise: the EIRP of the second antenna panel in the first transmission direction subtracted from the EIRP of the first antenna panel in the first transmission direction is greater than a threshold; and the EIRP of the first antenna panel in the second transmission direction subtracted from the EIRP of the second antenna panel in the second transmission direction is greater than the threshold. The threshold is a lower bound on a SIR achievable at the first TRP and the second TRP when the first antenna panel and the second antenna panel transmit at maximum power. The limiting the interference between the first antenna panel and the at least second antenna panel, EIRP requirements comprise: EIRP₁(θ₁,ϕ₁)−EIRP₂(θ₁,ϕ₁)>t₁ and EIRP₂(θ₂,ϕ₂)−EIRP₁(θ₂,ϕ₂)>t₁. The threshold t₁ is a lower bound on a SIR achievable at the first TRP and the second TRP when the first antenna panel and the second antenna panel transmit at maximum power.

Further, the communications manager 604 and/or other device components may be configured as or otherwise support the apparatus, such as a UE, including a transceiver; a set of antenna panels; a processor coupled to the transceiver, the processor and the transceiver configured to cause the apparatus to: receive a first signal from a first TRP in a first reception direction via a first antenna panel of the set of antenna panels; receive a second signal from a second TRP in a second reception direction via at least a second antenna panel of the set of antenna panels; and limit interference between the first antenna panel and the second antenna panel, the interference by the first antenna panel limited based at least in part on EIS of the first antenna panel in the second reception direction of the second TRP, and the interference by the second antenna panel limited based at least in part on the EIS of the second antenna panel in the first reception direction of the first TRP

Additionally, the apparatus (e.g., a UE) includes any one or combination of: an operability requirement of the apparatus comprises multi-panel reception from the respective first and second TRPs by the first antenna panel and the second antenna panel based at least in part on a percentage of a complementary cumulative distribution of the EIS within a limit on the interference received from the first antenna panel in the second reception direction of the second TRP, and from the second antenna panel in the first reception direction of the first TRP. To limit the interference between the first antenna panel and the at least second antenna panel, EIS requirements comprise: the EIS of the first antenna panel in the first reception direction subtracted from the EIS of the second antenna panel in the first reception direction is greater than a threshold; and the EIS of the second antenna panel in the second reception direction subtracted from the EIS of the first antenna panel in the second reception direction is greater than the threshold. The threshold is a lower bound on a SIR achievable at the first antenna panel and the second antenna panel when the first TRP and the second TRP transmit with a same EIRP. To limit the interference between the first antenna panel and the at least second antenna panel, EIS requirements comprise: EIS₂(θ₁,ϕ₁)−EIS₁(θ₁,ϕ₁)>t₂ and EIS₁(θ₂,ϕ₂)−EIS₂(θ₂,ϕ₂)>t₂. The threshold t₂ is a lower bound on a SIR achievable at the first antenna panel and the second antenna panel when the first TRP and the second TRP transmit with a same EIRP.

The communications manager 604 and/or other device components may be configured as or otherwise support a means for wireless communication and/or network signaling at a UE, including receiving a first signal from a first TRP in a first reception direction via a first antenna panel of a set of antenna panels; receiving a second signal from a second TRP in a second reception direction via at least a second antenna panel of the set of antenna panels; and limiting interference between the first antenna panel and the second antenna panel, the interference by the first antenna panel limited based at least in part on EIS of the first antenna panel in the second reception direction of the second TRP, and the interference by the second antenna panel limited based at least in part on the EIS of the second antenna panel in the first reception direction of the first TRP.

Additionally, wireless communication and/or network signaling at the UE includes any one or combination of: an operability requirement of the apparatus comprises multi-panel reception from the respective first and second TRPs by the first antenna panel and the second antenna panel based on a percentage of a complementary cumulative distribution of the EIS within a limit on the interference received from the first antenna panel in the second reception direction of the second TRP, and from the second antenna panel in the first reception direction of the first TRP. The limiting the interference between the first antenna panel and the at least second antenna panel, EIS requirements comprise: the EIS of the first antenna panel in the first reception direction subtracted from the EIS of the second antenna panel in the first reception direction is greater than a threshold; and the EIS of the second antenna panel in the second reception direction subtracted from the EIS of the first antenna panel in the second reception direction is greater than the threshold. The threshold is a lower bound on a SIR achievable at the first antenna panel and the second antenna panel when the first TRP and the second TRP transmit with a same EIRP. The limiting the interference between the first antenna panel and the at least second antenna panel, EIS requirements comprise: EIS₂(θ₁,ϕ₁)−EIS₁(θ₁,ϕ₁)>t₂ and EIS₁(θ₂,ϕ₂)−EIS₂(θ₂,ϕ₂)>t₂. The threshold t₂ is a lower bound on a SIR achievable at the first antenna panel and the second antenna panel when the first TRP and the second TRP transmit with a same EIRP.

Further, the communications manager 604 and/or other device components may be configured as or otherwise support the apparatus, such as a UE, including a transceiver; a set of antenna panels; a processor coupled to the transceiver, the processor and the transceiver configured to cause the apparatus to: transmit a signal from the transceiver via a best beam and at least a second-best beam of the set of antenna panels, the signal transmission coverage based at least in part on a sum of EIRP of the best beam and of the second-best beam where the second-best beam is the best beam from the set of antenna panels excluding the antenna panel of the best beam.

Additionally, the apparatus (e.g., a UE) includes any one or combination of: an operability requirement of the apparatus comprises multi-panel transmission from the set of antenna panels in terms of a percentage of the cumulative distribution of the sum of the EIRP received from the best beam and the second-best beam. The signal is transmitted from two best transmission antenna panels of the set of antenna panels based at least in part on a transmission direction to a TRP relative to the apparatus, the best beam and the second-best beam associated with the two best transmission antenna panels. The coverage reliability of the apparatus is based at least in part on the second-best beam being the best beam from a first antenna panel of the set of antenna panels being transmitted from other than a second antenna panel corresponding to the best beam, the coverage reliability mitigating the best beam being blocked for signal transmission.

The communications manager 604 and/or other device components may be configured as or otherwise support a means for wireless communication and/or network signaling at a UE, including initiating a signal from a transceiver for transmission; and transmitting the signal from the transceiver via a best beam and at least a second-best beam of a set of antenna panels, the signal transmission coverage based at least in part on a sum of EIRP of the best beam and of the second-best beam where the second-best beam is the best beam from the set of antenna panels excluding the antenna panel of the best beam.

Additionally, wireless communication and/or network signaling at the UE includes any one or combination of: an operability requirement comprises multi-panel transmission from the set of antenna panels in terms of the percentage of the cumulative distribution of the sum of the EIRP received from the best beam and the second-best beam. The transmitting the signal from two best transmission antenna panels of the set of antenna panels is based at least in part on a transmission direction to a TRP relative to the two best transmission antenna panels, the best beam and the second-best beam associated with the two best transmission antenna panels. The coverage reliability is based at least in part on the second-best beam being the best beam from a first antenna panel of the set of antenna panels being transmitted from other than a second antenna panel corresponding to the best beam, the coverage reliability mitigating the best beam being blocked for signal transmission.

Further, the communications manager 604 and/or other device components may be configured as or otherwise support the apparatus, such as a UE, including a transceiver; a set of antenna panels; a processor coupled to the transceiver, the processor and the transceiver configured to cause the apparatus to: receive a signal via a best beam and at least a second-best beam of the set of antenna panels, the signal reception coverage based at least in part on combined EIS of the best beam and of the second-best beam where the second-best beam is the best beam from the set of antenna panels excluding the antenna panel of the best beam.

Additionally, the apparatus (e.g., a UE) includes any one or combination of: the combined EIS is EIS_{C} comprising

$$E I {S}_{c} = {( \frac{1}{E I {S}_{1}} + \frac{1}{E I {S}_{2}} )}^{- 1} .$$

An operability requirement of the apparatus comprises multi-panel reception by the set of antenna panels in terms of the percentage of the complementary cumulative distribution of the combined EIS of the best beam and the second-best beam. The signal is received from two best reception antenna panels of the set of antenna panels based at least in part on a reception direction to a TRP relative to the apparatus, the best beam and the second-best beam associated with the two best reception antenna panels. The coverage reliability of the apparatus is based at least in part on the second-best beam being the best beam from a first antenna panel of the set of antenna panels being received at other than a second antenna panel corresponding to the best beam, the coverage reliability mitigating the best beam being blocked for signal reception.

The communications manager 604 and/or other device components may be configured as or otherwise support a means for wireless communication and/or network signaling at a UE, including receiving a signal; utilizing a best beam and at least a second-best beam of a set of antenna panels, the signal reception coverage based at least in part on combined EIS of the best beam and of the second-best beam where the second-best beam is the best beam from the set of antenna panels excluding the antenna panel of the best beam.

Additionally, wireless communication and/or network signaling at the UE includes any one or combination of: the combined EIS is EIS_{C} comprising

$$E I {S}_{c} = {( \frac{1}{E I {S}_{1}} + \frac{1}{E I {S}_{2}} )}^{- 1} .$$

An operability requirement comprises multi-panel reception by the set of antenna panels in terms of the percentage of the complementary cumulative distribution of the combined EIS of the best beam and the second-best beam. The receiving the signal from two best reception antenna panels of the set of antenna panels is based at least in part on a reception direction to a TRP relative to the two best reception antenna panels, the best beam and the second-best beam associated with the two best reception antenna panels. The coverage reliability is based at least in part on the second-best beam being the best beam from a first antenna panel of the set of antenna panels being received at other than a second antenna panel corresponding to the best beam, the coverage reliability mitigating the best beam being blocked for signal reception.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

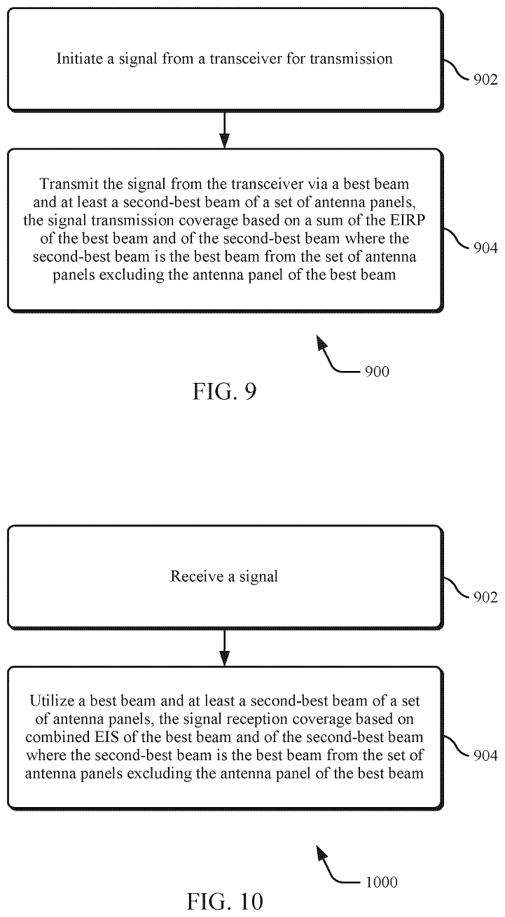

FIG. 7 illustrates a flowchart of a method 700 that supports multi-antenna panel transmission and reception in accordance with aspects of the present disclosure. The operations of the method 700 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 702, the method may include transmitting a first signal from a transceiver via a first antenna panel of a set of antenna panels to a first TRP in a first transmission direction. The operations of 702 may be performed in accordance with examples as described herein. In some implementations, aspects of the operations of 702 may be performed by a device as described with reference to FIG. 1.

At 704, the method may include transmitting a second signal from the transceiver via a second antenna panel of the set of antenna panels to a second TRP in a second transmission direction. The operations of 704 may be performed in accordance with examples as described herein. In some implementations, aspects of the operations of 704 may be performed by a device as described with reference to FIG. 1.

At 706, the method may include limiting interference between the first antenna panel and the second antenna panel, the interference by the first antenna panel limited based on the EIRP from the first antenna panel in the second transmission direction toward the second TRP, and the interference by the second antenna panel limited based on the EIRP from the second antenna panel in the first transmission direction toward the first TRP. The operations of 706 may be performed in accordance with examples as described herein. In some implementations, aspects of the operations of 706 may be performed by a device as described with reference to FIG. 1.

FIG. 8 illustrates a flowchart of a method 800 that supports multi-antenna panel transmission and reception in accordance with aspects of the present disclosure. The operations of the method 800 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 802, the method may include receiving a first signal from a first TRP in a first reception direction via a first antenna panel of a set of antenna panels. The operations of 802 may be performed in accordance with examples as described herein. In some implementations, aspects of the operations of 802 may be performed by a device as described with reference to FIG. 1.

At 804, the method may include receiving a second signal from a second TRP in a second reception direction via a second antenna panel of the set of antenna panels. The operations of 804 may be performed in accordance with examples as described herein. In some implementations, aspects of the operations of 804 may be performed by a device as described with reference to FIG. 1.

At 806, the method may include limiting interference between the first antenna panel and the second antenna panel, the interference by the first antenna panel limited based on the EIS of the first antenna panel in the second reception direction of the second TRP, and the interference by the second antenna panel limited based on the EIS of the second antenna panel in the first reception direction of the first TRP. The operations of 806 may be performed in accordance with examples as described herein. In some implementations, aspects of the operations of 806 may be performed by a device as described with reference to FIG. 1.

FIG. 9 illustrates a flowchart of a method 900 that supports multi-antenna panel transmission and reception in accordance with aspects of the present disclosure. The operations of the method 900 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 902, the method may include initiating a signal from a transceiver for transmission. The operations of 902 may be performed in accordance with examples as described herein. In some implementations, aspects of the operations of 902 may be performed by a device as described with reference to FIG. 1.

At 904, the method may include transmitting the signal from the transceiver via a best beam and at least a second-best beam of a set of antenna panels, the signal transmission coverage based on a sum of the EIRP of the best beam and of the second-best beam where the second-best beam is the best beam from the set of antenna panels excluding the antenna panel of the best beam. The operations of 904 may be performed in accordance with examples as described herein. In some implementations, aspects of the operations of 904 may be performed by a device as described with reference to FIG. 1.

FIG. 10 illustrates a flowchart of a method 1000 that supports multi-antenna panel transmission and reception in accordance with aspects of the present disclosure. The operations of the method 1000 may be implemented and performed by a device or its components, such as a UE 104 as described with reference to FIGS. 1 through 6. In some implementations, the device may execute a set of instructions to control the function elements of the device to perform the described functions. Additionally, or alternatively, the device may perform aspects of the described functions using special-purpose hardware.

At 1002, the method may include receiving a signal. The operations of 1002 may be performed in accordance with examples as described herein. In some implementations, aspects of the operations of 1002 may be performed by a device as described with reference to FIG. 1.

At 1004, the method may include utilizing a best beam and at least a second-best beam of a set of antenna panels, the signal reception coverage based on combined EIS of the best beam and of the second-best beam where the second-best beam is the best beam from the set of antenna panels excluding the antenna panel of the best beam. The operations of 1004 may be performed in accordance with examples as described herein. In some implementations, aspects of the operations of 1004 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined. The order in which the methods are described is not intended to be construed as a limitation, and any number or combination of the described method operations may be performed in any order to perform a method, or an alternate method.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C, or AB or AC or BC, or ABC (i.e., A and B and C). Similarly, a list of one or more of A, B, or C means A or B or C, or AB or AC or BC, or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
a transceiver;
a set of antenna panels;
at least one memory; and
at least one processor coupled with the at least one memory and configured to cause the UE to:
transmit a first signal from the transceiver via a first antenna panel of the set of antenna panels to a first transmission-reception point (TRP) in a first transmission direction;
transmit a second signal from the transceiver via at least a second antenna panel of the set of antenna panels to a second TRP in a second transmission direction; and
limit interference between the first antenna panel and the second antenna panel, the interference by the first antenna panel limited based at least in part on effective isotropic radiated power (EIRP) from the first antenna panel in the second transmission direction toward the second TRP, and the interference by the second antenna panel limited based at least in part on the EIRP from the second antenna panel in the first transmission direction toward the first TRP.

2. The UE of claim 1, wherein an operability requirement of the UE comprises multi-panel transmission from the first antenna panel and the second antenna panel in wireless communication with the respective first and second TRPs based at least in part on a percentage of a cumulative distribution of the EIRP within a limit on the interference from the first antenna panel in the second transmission direction toward the second TRP, and from the second antenna panel in the first transmission direction toward the first TRP.

3. The UE of claim 1, wherein, to limit the interference between the first antenna panel and the at least second antenna panel, EIRP requirements comprise:
the EIRP of the second antenna panel in the first transmission direction subtracted from the EIRP of the first antenna panel in the first transmission direction is greater than a threshold; and
the EIRP of the first antenna panel in the second transmission direction subtracted from the EIRP of the second antenna panel in the second transmission direction is greater than the threshold.

4. The UE of claim 3, wherein the threshold is a lower bound on a signal-to-interference ratio (SIR) achievable at the first TRP and the second TRP when the first antenna panel and the second antenna panel transmit at maximum power.

5. The UE of claim 1, wherein, to limit the interference between the first antenna panel and the at least second antenna panel, EIRP requirements comprise:
$$\begin{matrix}{EIRP}_{1} ( {θ}_{1} , {ϕ}_{1} ) - {EIRP}_{2} ( {θ}_{1} , {ϕ}_{1} ) > {t}_{1} \\ and \\ {EIRP}_{2} ( {θ}_{2} , {ϕ}_{2} ) - {EIRP}_{1} ( {θ}_{2} , {ϕ}_{2} ) > {t}_{1} .\end{matrix}$$

6. The UE of claim 5, wherein a threshold t₁ is a lower bound on a SIR achievable at the first TRP and the second TRP when the first antenna panel and the second antenna panel transmit at maximum power.

7. A user equipment (UE) for wireless communication, comprising:
a transceiver;
a set of antenna panels;
at least one memory; and
at least one processor coupled with the at least one memory and configured to cause the UE to:
receive a first signal from a first transmission-reception point (TRP) in a first reception direction via a first antenna panel of the set of antenna panels;
receive a second signal from a second TRP in a second reception direction via at least a second antenna panel of the set of antenna panels; and
limit interference between the first antenna panel and the second antenna panel, the interference by the first antenna panel limited based at least in part on effective isotropic sensitivity (EIS) of the first antenna panel in the second reception direction of the second TRP, and the interference by the second antenna panel limited based at least in part on the EIS of the second antenna panel in the first reception direction of the first TRP.

8. The UE of claim 7, wherein an operability requirement of the UE comprises multi-panel reception from the respective first and second TRPs by the first antenna panel and the second antenna panel based at least in part on a percentage of a complementary cumulative distribution of the EIS within a limit on the interference received from the first antenna panel in the second reception direction of the second TRP, and from the second antenna panel in the first reception direction of the first TRP.

9. The UE of claim 7, wherein, to limit the interference between the first antenna panel and the at least second antenna panel, EIS requirements comprise:
the EIS of the first antenna panel in the first reception direction subtracted from the EIS of the second antenna panel in the first reception direction is greater than a threshold; and
the EIS of the second antenna panel in the second reception direction subtracted from the EIS of the first antenna panel in the second reception direction is greater than the threshold.

10. The UE of claim 9, wherein the threshold is a lower bound on a signal-to-interference ratio (SIR) achievable at the first antenna panel and the second antenna panel when the first TRP and the second TRP transmit with a same effective isotropic radiated power (EIRP).

11. The UE of claim 7, wherein, to limit the interference between the first antenna panel and the at least second antenna panel, EIS requirements comprise:
$$\begin{matrix}EI {S}_{2} ( {θ}_{1} , {ϕ}_{1} ) - E I {S}_{1} ( {θ}_{1} , {ϕ}_{1} ) > {t}_{2} \\ and \\ {EIS}_{1} ( {θ}_{2} , {ϕ}_{2} ) - E I {S}_{2} ( {θ}_{2} , {ϕ}_{2} ) > {t}_{2} .\end{matrix}$$

12. The UE of claim 11, wherein a threshold t₂ is a lower bound on a SIR achievable at the first antenna panel and the second antenna panel when the first TRP and the second TRP transmit with a same effective isotropic radiated power (EIRP).

13. A user equipment (UE) for wireless communication, comprising:
a transceiver;
a set of antenna panels;
at least one memory; and
at least one processor coupled with the at least one memory and configured to cause the UE to transmit a signal from the transceiver via a best beam and at least a second-best beam of the set of antenna panels, a signal transmission coverage based at least in part on a sum of effective isotropic radiated power (EIRP) of the best beam and of the second-best beam where the second-best beam is the best beam from the set of antenna panels excluding an antenna panel of the best beam.

14. The UE of claim 13, wherein an operability requirement of the UE comprises multi-panel transmission from the set of antenna panels in terms of a percentage of a cumulative distribution of the sum of the EIRP received from the best beam and the second-best beam.

15. The UE of claim 13, wherein the signal is transmitted from two best transmission antenna panels of the set of antenna panels based at least in part on a transmission direction to a transmission-reception point (TRP) relative to the UE, the best beam and the second-best beam associated with the two best transmission antenna panels.

16. The UE of claim 13, wherein coverage reliability of the UE is based at least in part on the second-best beam being the best beam from a first antenna panel of the set of antenna panels being transmitted from other than a second antenna panel corresponding to the best beam, the coverage reliability mitigating the best beam being blocked for signal transmission.

17. The UE of claim 13, wherein the at least one processor is configured to cause the UE to receive an additional signal via the best beam and the at least second-best beam of the set of antenna panels, a signal reception coverage based at least in part on combined effective isotropic sensitivity (EIS) of the best beam and of the second-best beam where the second-best beam is the best beam from the set of antenna panels excluding the antenna panel of the best beam.

18. The UE of claim 17, wherein the combined EIS is EIS_{C} comprising:
$$E I {S}_{c} = {( \frac{1}{E I {S}_{1}} + \frac{1}{E I {S}_{2}} )}^{- 1} .$$

19. The UE of claim 17, wherein an operability requirement of the UE comprises multi-panel reception by the set of antenna panels in terms of a percentage of complementary cumulative distribution of the combined EIS of the best beam and the second-best beam.

20. The UE of claim 17, wherein the signal is received from two best reception antenna panels of the set of antenna panels based at least in part on a reception direction to a transmission-reception point (TRP) relative to the UE, the best beam and the second-best beam associated with the two best reception antenna panels.

21. A processor for wireless communication, comprising:
at least one controller coupled with at least one memory and configured to cause the processor to:
transmit a first signal from a transceiver via a first antenna panel of a set of antenna panels to a first transmission-reception point (TRP) in a first transmission direction;
transmit a second signal from the transceiver via at least a second antenna panel of the set of antenna panels to a second TRP in a second transmission direction; and
limit interference between the first antenna panel and the second antenna panel, the interference by the first antenna panel limited based at least in part on effective isotropic radiated power (EIRP) from the first antenna panel in the second transmission direction toward the second TRP, and the interference by the second antenna panel limited based at least in part on the EIRP from the second antenna panel in the first transmission direction toward the first TRP.
